(19) United States
(12) Patent Application Publication
(10) Pub. No.: US 2018/0226734 A1
(43) Pub. Date: Aug. 9, 2018

(54) PLUG CONNECTOR PART FOR A LOAD LINE

(71) Applicant: Phoenix Contact E-Mobility GmbH, Schieder-Schwalenberg (DE)

(72) Inventors: Thomas Fuehrer, Blomberg (DE); Johannes Held, Bielefeld (DE)

(73) Assignee: Phoenix Contact E-Mobility GmbH, Schieder-Schwalenberg (DE)

(21) Appl. No.: 15/579,961

(22) PCT Filed: Jun. 1, 2016
(86) PCT No.: PCT/EP2016/062332

§ 371 Date: Dec. 6, 2017

(30) Foreign Application Priority Data
Jun. 8, 2015 (DE) 10 2015 108 940.8

(51) Int. Cl. H01R 11/32; H01R 24/28; H01R 31/00; B60L 11/18

(52) U.S. Cl. CPC H01R 11/32; H01R 24/28; H01R 2107/00; B60L 11/1818; H01R 2201/26; H01R 31/00

(57) ABSTRACT

A plug connector part for connecting to a mating plug connector part includes: an electrical power contact element for transmitting an electrical load current between the plug connector part and the mating plug connector part; and an electrical load line connected to the power contact element. The load line has a plurality of individual lines which are electrically connected to the associated power contact element in order to transmit a charging current via the power contact element.

### CROSS-REFERENCE TO PRIOR APPLICATIONS

This application is a U.S. National Phase application under 35 U.S.C. § 371 of International Application No. PCT/EP2016/062332, filed on Jun. 1, 2016, and claims benefit to German Patent Application No. DE 10 2015 108 940.8, filed on Jun. 8, 2015. The International Application was published in German on Dec. 15, 2016 as WO 2016/198297 under PCT Article 21(2).

### FIELD

The invention relates to a plug connector part for connecting to a mating plug connector part.

### BACKGROUND

A plug connector part of this type comprises one or more electrical power contact elements for transmitting an electrical load current between the plug connector part and the mating plug connector part. Connected to at least one power contact element is an electrical load line which carries the charging current to the associated power contact element or away from the associated power contact element.

A plug connector part of this type can be used in particular on a charging device for transmitting a charging current. In this case, the plug connector part can be used in particular as a charging plug, for example on a charging cable, or as a charging socket, for example on a vehicle or at a charging station, and electrically charges a battery of a motor vehicle driven by an electric motor (also known as an electric vehicle).

Plug connector parts for use on a charging device for charging an electric vehicle are to be configured such that high charging currents can be transmitted. Since a charging procedure is to be carried out quickly, ever higher charging currents are used which, however, means that it is necessary to reduce the heat which is generated in the plug connector part and in the connected load lines in order to prevent the plug connector part and the load lines connected to the power contact elements of the plug connector part from heating up (excessively). In this case, the amperages can move within a range of more than 50 A, it also being possible for charging currents, in particular DC charging currents, of more than 100 A to flow.

In general, in order to transmit a high load current via a load line, it is necessary to use an electrical line, for example a copper line, which has a large cross section. However, this involves an increased weight of the line as well as higher costs. Instead of reducing ohmic losses in a load line by using lines of a large cross section, it may therefore be preferred to remove the heat generated at a load line in a suitable manner to thus prevent (excessive, inadmissible) heating of the line.

### SUMMARY

In an embodiment, the present a plug connector part for connecting to a mating plug connector part, comprising: an electrical power contact element configured to transmit an electrical load current between the plug connector part and the mating plug connector part; and an electrical load line connected to the power contact element, wherein the load line has a plurality of individual lines which are electrically connected to the associated power contact element in order to transmit a charging current via the power contact element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of an electric vehicle having a charging device connected thereto;

FIG. 2A is a perspective view of an embodiment of a plug connector part in the form of a charging socket of a vehicle;

FIG. 2B is another perspective view of the plug connector part according to FIG. 2A;

FIG. 3 is a side view of a load line connected to a power contact element of the plug connector part; and

FIG. 4 is a perspective view of the load line according to FIG. 3.

### DETAILED DESCRIPTION

In an embodiment, the present invention provides a plug connector part for a load line. The load line has a plurality of individual lines which are electrically connected to the associated power contact element in order to transmit a load current via the power contact element.

The plug connector part has one or more electrical power contact elements. A load line is connected to at least one of these power contact elements, each load line consisting of a plurality of individual lines. Thus, the current flow via a power contact element takes place via the individual lines of the load line connected to the power contact element.

This is based on the fundamental concept of distributing the load current, to be transmitted via a power contact element, over a plurality of individual lines, so that only part of the current flows through each individual line and thus a line of a smaller cross section can be selected for each individual line. The use of a plurality of individual lines of a smaller cross section increases the overall surface area of the load line, so that the emission of heat from the load line is improved and consequently thermal energy can be removed more favorably from the load line. In general, the ratio between surface area and volume in lines of a small cross section is greater than in the case of lines of a large cross section. Thus, when subjected to the same current density, a line having a small cross section has a lower equilibrium temperature than a line which has a large cross section, because thermal energy can be emitted more favorably over the surface area of the line.

The load current which is to be transmitted via a power contact element is thus divided over a plurality of individual lines. Each of the individual lines is electrically connected to the associated power contact element and the individual lines thus lie together on the potential of the power contact element. If the individual lines are identically dimensioned, they each transmit an identical proportion of the load current. For example, if four individual lines are used per load line, each individual line transmits a quarter of the total load current to be transmitted via the power contact element.

In an advantageous embodiment, the individual lines can be electrically connected to a busbar, for example, which is connected to the power contact element. The busbar can extend, for example, in a rib-like manner transversely to a longitudinal direction in which the individual lines extend, and said busbar electrically contacts the power contact element, for example in that the busbar is rigidly connected, for example soldered or welded, to the power contact element, or is formed integrally with the power contact element. The individual lines extend from the busbar, so that a load current is divided among the individual lines by the busbar or is conveyed to the power contact element.

In a specific embodiment, the individual lines are mutually spaced apart transversely to the longitudinal direction in which the individual lines extend. The individual lines are thus mutually spaced and do not directly rest against one another, which promotes emission of heat from the individual lines and in particular allows air to flow around the individual lines. For example, the individual lines can be kept at a distance from one another by one or more spacers, the individual lines extending from the busbar for example in a plane spanned by the longitudinal direction and by a vertical direction which is specified by the busbar. The individual lines are thus mutually offset in the vertical direction, adjacent individual lines being kept at a distance from one another by one or more spacers, for example by ribs which extend between adjacent individual lines.

The individual lines are preferably electrically insulated in each case, in that they are sheathed by an insulating material along their longitudinal direction. Thus, starting from the busbar connected to the power contact element, for example, each individual line extends in an associated insulating sheath and is thus electrically insulated from the outside.

In this case, the spacers can be realized by ribs extending between the insulating sheaths. For example, insulating sheaths of two adjacent individual lines can be interconnected by ribs, so that the individual lines are kept at a distance from one another by the ribs and the individual lines are thus prevented from lying directly against one another. In this case, when viewed in the longitudinal direction, gaps are located between the ribs, through which gaps air can flow, thereby allowing air to flow around the individual lines to improve the emission of thermal energy.

The plug connector part preferably comprises a plurality of power contact elements which are each connected to a load line. The power contact elements can be used to transmit a direct current, for example, it also being conceivable and possible for a single-phase or multi-phase alternating current to be transmitted via the power contact elements

The individual lines can for example be configured flexibly, for example, when used in a charging cable of a charging system for charging an electric vehicle, so that the individual lines can be bent and for example a charging cable can consequently be laid in a variable manner. For this purpose, the individual lines can be formed, for example, by single-core copper lines or by strands, it being possible for the individual lines to each have a relatively small cross section. The transmission of high load currents can be made possible, for example, using a plurality of individual lines which each transmit only a proportion of the load current.

The plug connector part can be a component of a charging system for charging an electric vehicle. In this case, the plug connector part comprising its power contact elements and the load lines connected thereto is used for transmitting a charging current, for example a direct current or an alternating current of a relatively high amperage, for example of more than 50 A, in particular more than 80 A or even more than 100 A.

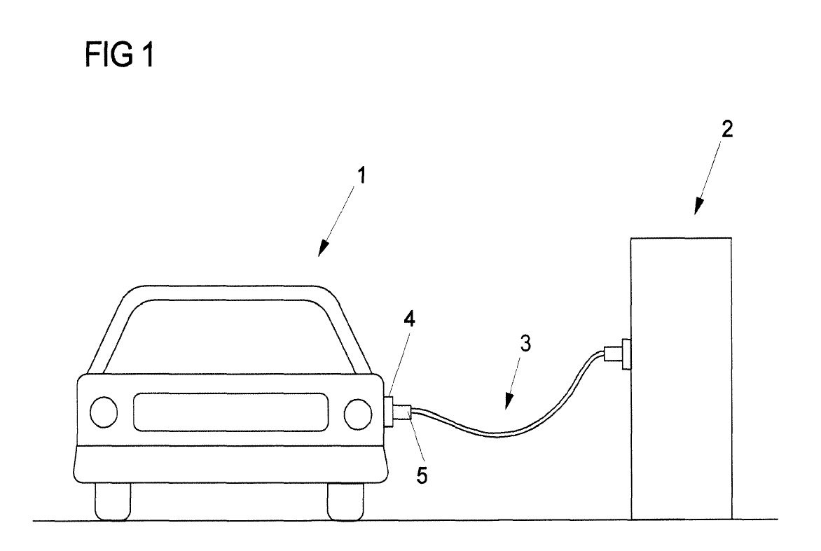

FIG. 1 is a schematic view of a vehicle 1 in the form of a vehicle driven by an electric motor (hereafter called an electric vehicle). The electric vehicle 1 has electrically chargeable batteries by means of which an electric motor for moving the vehicle 1 can be supplied with electrical power.

To charge the batteries of the vehicle 1, the vehicle 1 can be connected to a charging station 2 by a charging cable 3. For this purpose, one end of the charging cable 3 can be plugged into an associated charging socket 4 of the electric vehicle 1 by a plug connector part 5 in the form of a charging plug, and the other end of said charging cable is electrically connected to a charging station 2. The charging cable 3 transmits charging currents of a relatively high amperage to the vehicle 1.

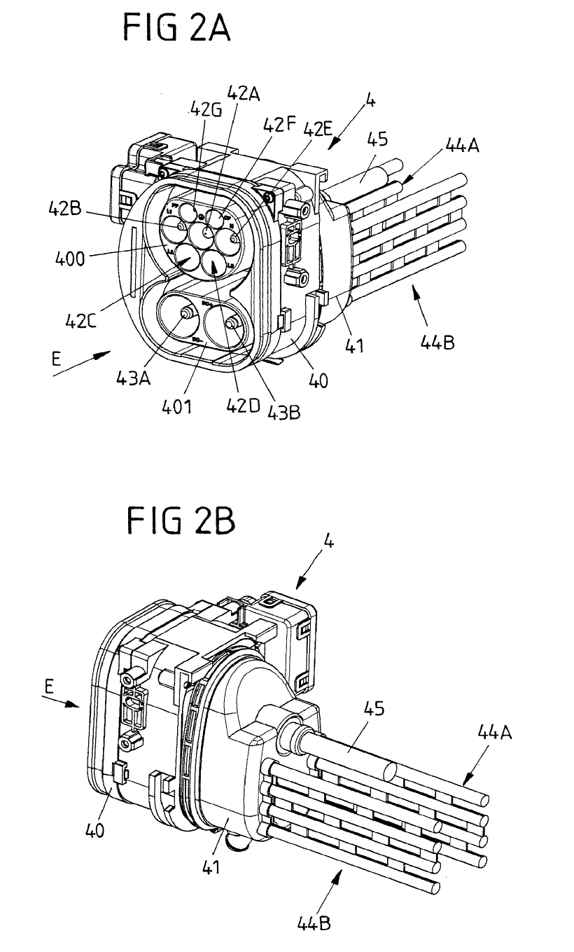

FIGS. 2A and 2B show an embodiment of a plug connector part 4 in the form of a charging socket. The plug connector part 4 which is configured in this embodiment as what is known as a CCS plug connector (CCS stands for combined AC/DC-charging system) and is suitable for transmitting a charging current as a direct current or as an alternating current comprises a housing 40 having two insertion portions 400, 401 which can be brought into insertion engagement with the associated charging plug 5 on the charging cable 3 (see FIG. 1). Projecting into the insertion portions 400, 401 in an insertion direction E are elongate contact elements 42A-42G, 43A, 43B in the form of contact pins which are brought into insertion engagement, in a manner known per se, with associated female contacts of the charging plug 5 in the insertion direction E.

A charging current in the form of an alternating current can be transmitted by the contact elements 42A-42G of the insertion portion 400. Of the contact elements 42A-42G, the contact elements 42B-42E, arranged around the central contact element 42A along a semicircle, are used as what are known as power contacts for transmitting the (high) charging currents.

Of the contact elements 42A-42E, the contact elements 42B-42D can be used, for example, as outer conductor contacts (also denoted by “L1”, “L2” and “L3”), while the contact element 42D can be used as a neutral conductor (also denoted by the letter “N”) and the centrally arranged contact element 42A can be used as an earthing contact (also denoted by “PE”). These power contact elements 42A-42E are used to transmit a charging current in the form of a single-phase or multi-phase, for example a three-phase, alternating current having an effective value of, for example, between 50 A and 100 A and a voltage of, for example, between 400 V and 600 V.

The additional contact elements 42F, 42G are used for signaling. Thus, the contact element 42F is a signal contact element (also referred to as a “control pilot”, abbreviated to “CP”) which can transmit signaling information. In contrast, the contact element 42G is used as what is known as a proximity contact (also referred to as a “proximity pilot”, abbreviated to “PP”). The signal contact element 42F can, for example, transmit a square wave voltage, by means of which information about a maximally available charging power can be transmitted from the charging station 2 to the vehicle 1. In contrast, the proximity contact 42G can establish the presence of a charging plug 5 in the charging socket 4.

In contrast, the contact elements 43A, 43B of the lower, second insertion portion 401 can transmit a charging current in the form of a direct current. The charging socket 4 can thus be used within a charging system which can transmit direct currents as well as alternating currents for charging the electric vehicle 1.

In the embodiment shown of the charging socket 4, connected to each contact element 43A, 43B at the lower second insertion portion 401 is a load line 44A, 44B which consists of a plurality of individual lines 442. A charging current is thus not transmitted by a single line, but in a divided manner by the plurality of individual lines 442. Therefore, since each individual line 442 does not have to transmit the full charging current, but only a proportion of the charging current, the individual lines 442 can be configured having a relatively small line cross section, for example, as single-core copper lines or as strands.

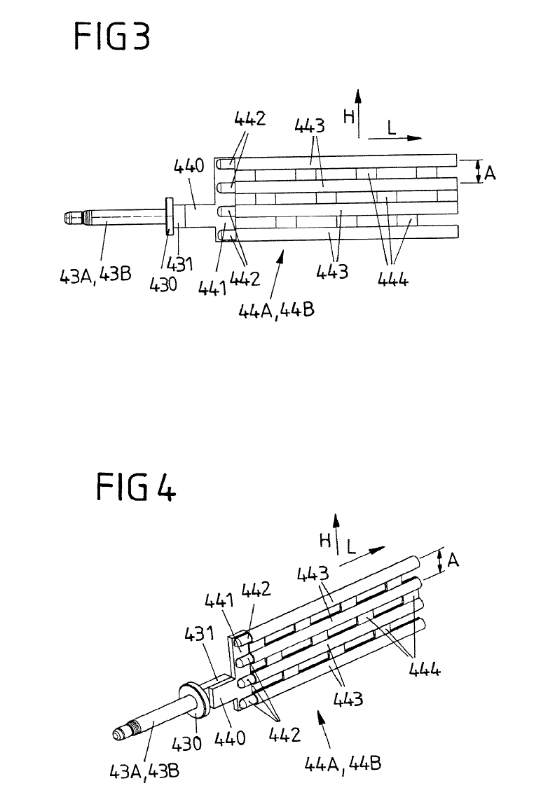

As can be seen from the views according to FIGS. 3 and 4, the individual lines 442 are connected to a busbar 441 which is electrically connected to the associated contact element 43A, 43B by a connecting portion 440. For this purpose, the planar connecting portion 440 rests in an electrically contacting manner on a planar connecting portion 431 on the back of a plate 430 of the associated contact element 43A, 43B and is connected rigidly thereto, in particular is soldered or welded or formed integrally, i.e. in one piece, therewith.

The busbar 441 extends in a vertical direction H transversely to the insertion direction E and transversely to a longitudinal direction L in which the individual lines 442 extend from the busbar 441. The individual lines 442 are connected to the busbar 441 and extend perpendicularly away from the busbar 441 in the longitudinal direction L.

The individual lines 442 are arranged on the busbar 441 so as to be offset in the vertical direction H and they are at a distance A (viewed in the vertical direction H) from one another. Each individual line 442 is enclosed by an insulating sheath 443, produced for example from an electrically insulating plastics material, along its longitudinal direction L and is thus electrically insulated from the outside by the insulating sheath 443.

The individual lines 442 extend in a plane spanned by the vertical direction H and by the longitudinal direction L, and are mutually offset in this plane such that the distance A is produced between adjacent individual lines 442.

In order to keep the individual lines 442 at a distance A from one another in the longitudinal direction L, plastics spacers in the form of ribs 444 are arranged between two adjacent individual lines 442 in each case and prevent adjacent individual lines 442 from resting against one another. The ribs 444 can be formed integrally with the insulating sheaths 443 of the adjacent individual lines 442. In this case, a plurality of ribs 444 is arranged in the longitudinal direction L so as to be periodically mutually offset, thereby producing gaps between the ribs 444.

Since the load line 44A, 44B is divided into individual lines 442, each individual line 442 does not have to be configured to transmit the entire load current, but only a proportion thereof, this being a quarter of the total current in the embodiment shown. The individual lines 442 can thus be configured having a relatively small cross section.

Since a plurality of individual lines 442 is used, the surface area of the load line 44A, 44B is increased, which promotes the emission of thermal energy. Furthermore, since a greater ratio between surface area and volume results when the line cross section is relatively small, the equilibrium temperature of each individual line 442, with the same load-independent current density, is lower than in the case of a line of a larger cross section. Thus, each individual line 442 per se and the individual lines 442 of the load line 44A, 44B overall allow a favorable emission of thermal energy to the surroundings, which can be further improved by air flowing around the load line 44A, 44B.

The individual lines 442 are preferably configured to be flexible, so that the load line 44A, 44B can be laid in a variable manner. For example, the individual lines 442 are configured as single-core copper lines (having a relatively small cross section) or as strands. In the present context, a strand is understood as meaning an electrical conductor which consists of thin individual wires and is therefore easy to bend. The individual wires are formed, for example, as copper wires.

In the embodiment shown of the charging socket 4, (only) the contact elements 43A, 43B of the insertion portion 401 are connected to a load line 44A, 44B of the type shown in FIGS. 3 and 4 in order to transmit a direct current. In contrast, the contact elements 42A-42E of the insertion portion 400 are each connected to a single-core load line, which lines are combined in a line 45 and are guided away from the charging socket 4. In this connection, it is of course also conceivable and possible for the contact elements 42A-42E of the insertion portion 400 to be connected to load lines which consist of a plurality of individual lines, in order to transmit an alternating current.

The individual lines 442 of the load lines 44A, 44B emerge from a housing portion 41 at the back of the housing 40 of the charging socket 4, the busbar 441 being enclosed in the housing portion 41 and the individual lines 442 being fully sheathed by their insulating sheaths 443 outside the housing 40.

The fundamental concept of the invention is not restricted to the above embodiments, but in principle it can also be realized in a completely different way.

Thus, a plug connector part of the type described here can be used on a vehicle as a charging socket or it can also be used on a charging cable as a charging plug. In the latter case, the load lines are laid inside the charging cable.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 vehicle
2 charging station
3 charging cable
4 plug connector part (charging socket)
40 housing
400, 401 insertion portion
41 housing portion
42A-42G contact element (contact pin)
43A, 43B contact element (contact pin)
430 plate
431 connecting portion
44A, 44B load line
440 connecting portion
441 rib
442 individual line
443 insulating sheath
444 spacer
45 line
5 plug connector part (charging plug)
A distance
E insertion direction
L longitudinal direction
H vertical direction

1. A plug connector part for connecting to a mating plug connector part, comprising:
an electrical power contact element configured to transmit an electrical load current between the plug connector part and the mating plug connector part; and
an electrical load line connected to the power contact element,
wherein the load line has a plurality of individual lines which are electrically connected to the associated power contact element in order to transmit a charging current via the power contact element.

2. The plug connector part according to claim 1, wherein the individual lines are brought into electrical contact with a busbar which is connected to the power contact element.

3. The plug connector part according to claim 2, wherein the busbar extends transversely to a longitudinal direction in which the individual lines extend.

4. The plug connector part according to claim 1, wherein the individual lines are mutually spaced transversely to a longitudinal direction in which the individual lines extend.

5. The plug connector part according to claim 4, wherein the individual lines are kept at a distance from one another by at least one spacer.

6. The plug connector part according to claim 1, wherein the individual lines each have an electrically insulating sheath which sheathes the associated individual line along its longitudinal direction.

7. The plug connector part according to claim 6, wherein ribs are arranged between the insulating sheaths of two adjacent individual lines in order to keep the individual lines at a distance from one another.

8. The plug connector part according to claim 1, wherein the plug connector part comprises a plurality of power contact elements which are each connected to a load line.

9. The plug connector part according to claim 1, wherein the power contact element is configured to transmit a direct current.

10. The plug connector part according to claim 1, wherein the individual lines are flexible.

11. The plug connector part according to claim 1, wherein the individual lines are comprised of single-core copper lines or of strands.

12. A charging system for charging an electric vehicle, comprising the plug connector part according to claim 1.
